(19) United States
(12) Patent Application Publication
(10) Pub. No.: US 2006/0077128 A1
(43) Pub. Date: Apr. 13, 2006

(54) Plasma display device and method for driving the same

(76) Inventors: Su-Yong Chae, Suwon-si (KR); Hak-Cheol Yang, Suwon-si (KR); Sang-Hoon Yim, Suwon-si (KR)

Correspondence Address: CHRISTIE, PARKER & HALE, LLP, PO BOX 7068, PASADENA, CA, 91109-7068, US

(21) Appl. No.: 11/138,820

(22) Filed: May 25, 2005

(30) Foreign Application Priority Data
Oct. 11, 2004 (KR) 10-2004-0080866

(51) Int. Cl. G09G 3/28

(52) U.S. Cl. 345/60

(57) ABSTRACT

A plasma display device and a method for driving the plasma display device. Only some row electrodes are addressed in a sub-field having the smallest weight to reduce the luminance of the sub-field having the smallest weight. Only odd-numbered row electrodes are addressed in an odd-numbered frame and only even-numbered row electrodes are addressed in an even-numbered frame in the address period of the sub-field with the smallest weight. The length of the sustain period of a sub-field having the second smallest weight is identical to the length of the sustain period of the sub-field having the smallest weight. Then, the ratio of the luminances of the two sub-fields is increased by twice to improve representation of lower gray scale.

### CROSS REFERENCE TO RELATED APPLICATION

This application claims priority to and the benefit of Korean Patent Application No. 10-2004-0080866 filed in the Korean Intellectual Property Office on Oct. 11, 2004, the content of which is incorporated herein by reference.

### BACKGROUND OF THE INVENTION

(a) Field of the Invention

The present invention relates to a plasma display device and a method for driving the same. More specifically, the present invention relates to a method for representing lower gray scales in a plasma display device.

(b) Description of the Related Art

A plasma display device displays characters or images using plasma generated by gas discharging. A display panel of the plasma display device has a plurality of pixels (discharge cells) arranged in a matrix form. The pixels have only a function of lighting light or not when an image is displayed. Thus, the gray scale of a pixel in the plasma display panel is determined by a period of time during which the pixel emits light. For this, the plasma display panel is driven such that one frame is divided into a plurality of sub-fields having respective weights. The weight of a sub-field determines a period of time during which pixels emit light in the sub-field, and sub-fields having pixels emitting light among the plurality of sub-fields are combined to represent gray scales.

When a lower gray scale, that is, a dark part, is represented in a display device, the lower gray scale is distinctly deteriorated when the luminance of the lower gray scale is excessively high. The plasma display panel uses sub-fields having smaller weights, that is, sub-fields having a small number of sustain discharge pulses, to represent the lower gray scale. However, light intensity of one sub-field includes not only light intensity caused by sustain discharge but also light intensity caused by address discharge for selecting cells to be lit in the plasma display panel. Accordingly, even when the number of sustain discharge pulses is reduced, there is a limitation in decreasing the light intensity. Particularly, emission efficiency has been improved recently to result in excessively high light intensity caused by one-time sustain discharge or address discharge. This increases light intensity of sub-fields having smaller weights. Accordingly, lower gray scale is represented excessively brightly.

### SUMMARY OF THE INVENTION

The present invention provides a method for driving a plasma display device, which reduces the luminance of sub-fields having smaller weights to improve representation of lower gray scale.

The present invention addresses only some of the row electrodes in a sub-field having a smaller weight.

In one aspect of the present invention, there is provided a plasma display device in which cells corresponding to some of a plurality of row electrodes are set to non-lit cells all the time in at least one sub-field. A plasma display panel includes a plurality of row electrodes, a plurality of column electrodes intersecting the row electrodes, and a plurality of cells respectively defined by the row electrodes and column electrodes. A controller divides one field into a plurality of sub-fields having respective weights, and generates control signals for controlling driving of the row electrodes and column electrodes from video data. In addition, the controller calculates a display load ratio from the video data, and determines the number of sustain discharge pulses allocated to each of the sub-fields in response to the display load ratio. A driver selects cells to be lit from the plurality of cells in an address period of each sub-field, and applies sustain discharge pulses of as many as the weight of each sub-field to the row electrodes in a sustain period of each sub-field such that the selected cells are lit for a period of time corresponding to the number of the sustain discharge pulses.

The controller may determine the row electrodes corresponding to the cells set to be non-lit cells frame by frame.

The sub-field in which the cells corresponding to some of the row electrodes may be set to be non-lit cells may have a luminance lower than 10 cd/m² when all of the row electrodes are addressed.

The controller may set the cells corresponding to some of the row electrodes to the non-lit cells when the display load ratio is higher than a critical value.

The number of sustain discharge pulses allocated to the sub-field in which the cells corresponding to some of the row electrodes to the non-lit cells may be identical to the number of sustain discharge pulses allocated to a sub-field having a weight that is larger than and next to the weight of the sub-field.

In another aspect of the present invention, there is provided a method for driving a plasma display device including a plurality of row electrodes, a plurality of column electrodes intersecting the row electrodes, and a plurality of cells respectively defined by the row electrodes and column electrodes, one field being divided into a plurality of sub-fields having respective weights. The method selects cells to be lit from cells corresponding to row electrodes of a first group among the plurality of row electrodes in at least one first sub-field of a first frame, and lights the selected cells for a period corresponding to the weight of the first sub-field. Then, the method selects cells to be lit from the cells corresponding to the plurality of row electrodes in at least one second sub-field of the first frame, and lights the selected cells for a period corresponding to the weight of the second sub-field. Subsequently, the method selects cells to be lit from cells corresponding to row electrodes of a second group among the plurality of row electrodes in the first sub-field of a second frame, and lights the selected cells for a period corresponding to the weight of the first sub-field. Then, the method selects cells to be lit from the cells corresponding to the plurality of row electrodes in at least one second sub-field of the second frame, and lights the selected cells for a period corresponding to the weight of the second sub-field.

In another aspect of the present invention, the number of row electrodes addressed at a first display load ratio is smaller than the number of row electrodes addressed at a second display load ratio lower than the first display load ratio in at least one first sub-field.

### BRIEF DESCRIPTION OF THE DRAWINGS

FIG. 1 illustrates a plasma display panel according to a first embodiment of the present invention.

FIG. 2 illustrates frames divided into a plurality of sub-fields according to the first embodiment of the present invention.

FIG. 3 illustrates frames divided into a plurality of sub-fields according to a second embodiment of the present invention.

FIG. 4 is a block diagram of a controller of a plasma display device according to a third embodiment of the present invention.

FIG. 5 is a graph showing the relationship between a critical flicker frequency and luminance.

FIG. 6 illustrates frames divided into a plurality of sub-fields according to a fourth first embodiment of the present invention.

### DETAILED DESCRIPTION OF THE EXEMPLARY EMBODIMENTS

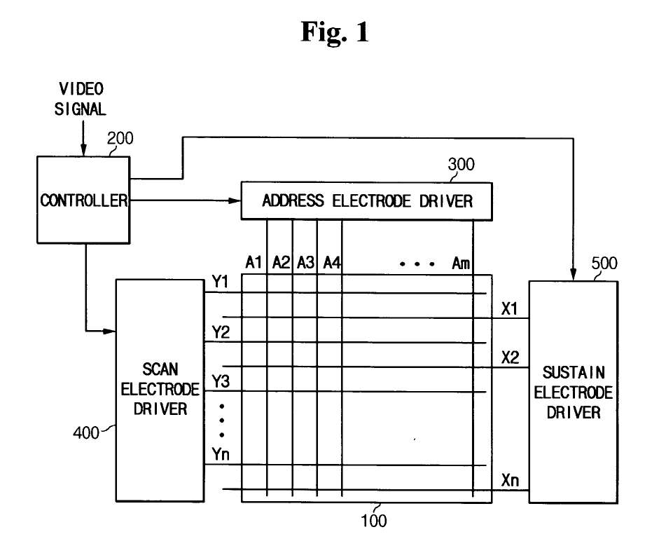

Referring to FIG. 1, the plasma display device includes a plasma display panel 100, a controller 200, an address electrode driver (referred to as “A electrode driver”) 300, a sustain electrode driver (referred to as “X electrode driver”) 400, and a scan electrode driver (referred to as “Y electrode driver) 500.

The plasma display panel 100 includes a plurality of row electrodes that are extended in a row direction and carry out scanning and displaying operations, and a plurality of column electrodes that are extended in a column direction and execute an addressing operation. In FIG. 1, the column electrodes are illustrated as address electrodes A₁ to Aₘ (referred to as “A electrodes”) and the row electrodes are shown as sustain electrodes X₁ to Xₙ (referred to as “X electrodes”) and scan electrodes Y₁ to Yₙ (referred to as “Y electrodes”). The X electrodes and the Y electrodes are paired. Discharge cells are respectively formed at discharge spaces respectively disposed at the intersections of the A electrodes A₁ to Aₘ and the X and Y electrodes X₁ to Xₙ and Y₁ to Yₙ.

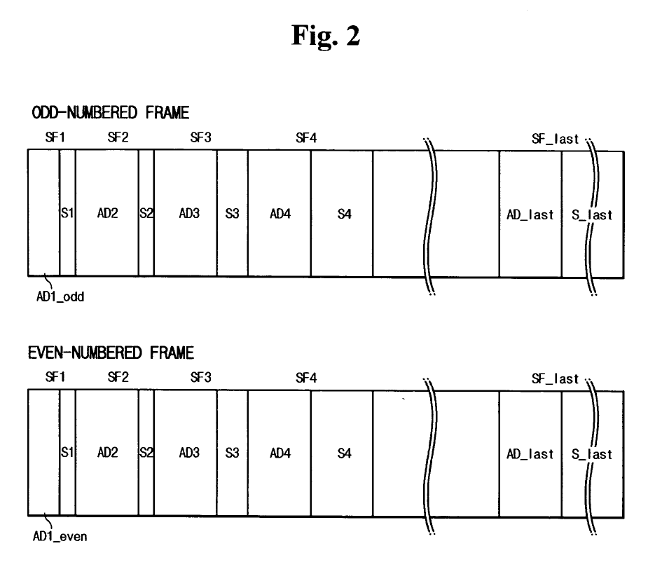

The controller 200 receives a video data signal from an external device and outputs an address electrode driving control signal, a sustain electrode driving control signal, and a scan electrode driving control signal. Furthermore, the controller 200 divides one frame into a plurality of sub-fields SF1 to SF9 respectively having weights, as shown in FIG. 2. In FIG. 2, sub-fields SF1 to SF_last are arranged in order of weights. The sub-fields SF1 to SF_last include address periods AD1_odd to AD_last or AD1_even to AD_last for selecting cells to be lit from a plurality of cells and sustain periods S1 to S_last for sustain-discharging the selected cells for a period corresponding to the weights of corresponding sub-fields, respectively. Furthermore, every sub-field or some of the sub-fields can further include a reset period for initializing the states of the cells.

In the address periods AD1_odd to AD_last or AD1_even to AD_last, the A electrode driver 300 and the Y electrode driver 500 carry out an addressing operation for selecting lit cells. Specifically, the Y electrode driver 400 selectively (for example, sequentially) applies a scan voltage to the Y electrodes Y₁ to Yₙ, and the A electrode driver 300 receives the address driving control signal from the controller 200 and applies an address pulse having an address voltage for selecting the lit cells to each of the A electrodes whenever the scan pulse is applied to each of the Y electrodes. Here, a non-address voltage (generally, ground voltage) is applied to non-lit cells. That is, cells formed by Y electrodes to which the scan pulse is applied in the address period and A electrodes to which the address pulse is applied when the scan pulse is supplied to the Y electrodes are selected as lit cells.

In the sustain periods S1 to S_last, the X electrode driver 400 and the Y electrode driver 500 receive control signals from the controller 200 and alternately apply a sustain discharge pulse to the X electrodes X₁ to Xₙ, and the Y electrodes Y₁ to Yₙ. The number of the sustain discharge pulses is determined by the weight of a corresponding sub-field. Then, discharge of as many as the number of sustain discharge pulses occurs by the sustain discharge pulses in the cells selected in the address period AD1_odd to AD_last or AD1_even to AD_last.

In the first embodiment of the present invention, the controller 200 transmits control signals to the A electrode driver 300 and the Y electrode driver 500 such that the addressing operation is executed only for odd-numbered row electrodes or even-numbered row electrodes among the plurality of row electrodes in the address period AD1_odd or AD_even of the sub-field SF1 having the minimum weight. In addition, the controller 200 selects lit cells in the even-numbered row electrodes in even-numbered frames if lit cells are selected in the odd-numbered row electrodes in an odd-numbered frame, for example. That is, the Y electrode driver 500 selectively applies the scan pulse only to odd-numbered Y electrodes Y₁, Y₃, . . . , Yₙ₋₁ in the address period AD1_odd of the sub-field SF1 with the minimum weight of an odd-numbered frame, and selectively applies the scan pulse only to even-numbered Y electrodes Y₂, Y₄, . . . , Yₙ in the address period AD1_even of the sub-field SF1 with the minimum weight of an even-numbered frame. Whenever the scan pulse is applied, the A electrode driver 300 applies the address pulse to A electrodes corresponding to cells selected as lit cells among cells formed in the Y electrodes to which the scan pulse is applied. Consequently, the luminance of the sub-field SF1 with the minimum weight is reduced by half as compared to the case where the addressing operation is executed for the row electrodes.

That is, the number of cells in which address discharge occurs in the address period is reduced by approximately half and the number of cells in which sustain discharge occurs in the sustain period is decreased by approximately half so that the luminance is reduced by half. Here, if the number of sustain discharge pulses of the next sub-field SF2 is identical to the number of sustain discharge pulses of the sub-field SF1, the luminance of the sub-field SF1 becomes half the luminance of the sub-field SF2. Accordingly, the luminance of gray scale 1 is reduced to a half of the luminance of gray scale 2 in the prior art (that is, when the sub-field SF2 is used as the sub-field SF having the minimum weight) to improve representation of a lower gray scale.

Furthermore, since the addressing operation is executed only for a half of the row electrodes in the sub-field SF1, the length of the address period AD1_off or AD1_even corresponds to a half of the address period of the sub-field SF2 and thus the sub-field SF1 adds only a little time to the period of the corresponding frame.

The first embodiment of the present invention alternately addresses the odd-numbered row electrodes and the even-numbered row electrodes in the sub-field SF1 to reduce the luminance of the sub-field SF1 to approximately half of the luminance of the sub-field SF2. However, when every sub-field SF1 to SF_last includes a reset period and light intensity of the reset period is considerably high, the luminance of the sub-field SF1 may not be half of the luminance of the sub-field SF2. In this case, the plurality of row electrodes are divided into a plurality of groups in the sub-field SF1 and one of the groups is selectively addressed for each frame. For instance, it is possible to divide the plurality of row electrodes into three groups including a (3i-2)th row electrode, a (3i-1)th row electrode and a (3i)th row electrode and address only one of the groups for each frame.

While one frame includes only one sub-field SF1 that addresses some of the row electrodes in the first embodiment of the present invention, one frame can include multiple sub-fields SF1. For instance, a sub-field having sustain discharge pulses of as many as the number of sustain discharge pulses of the sub-fields SF1 and SF2 is added to the sub-field structure of FIG. 2 and the added sub-field addresses only a quarter of the row electrodes. In this case, the luminance of the added sub-field becomes approximately half of the luminance of the sub-field SF1 so that representation of the lower gray scale can be further improved.

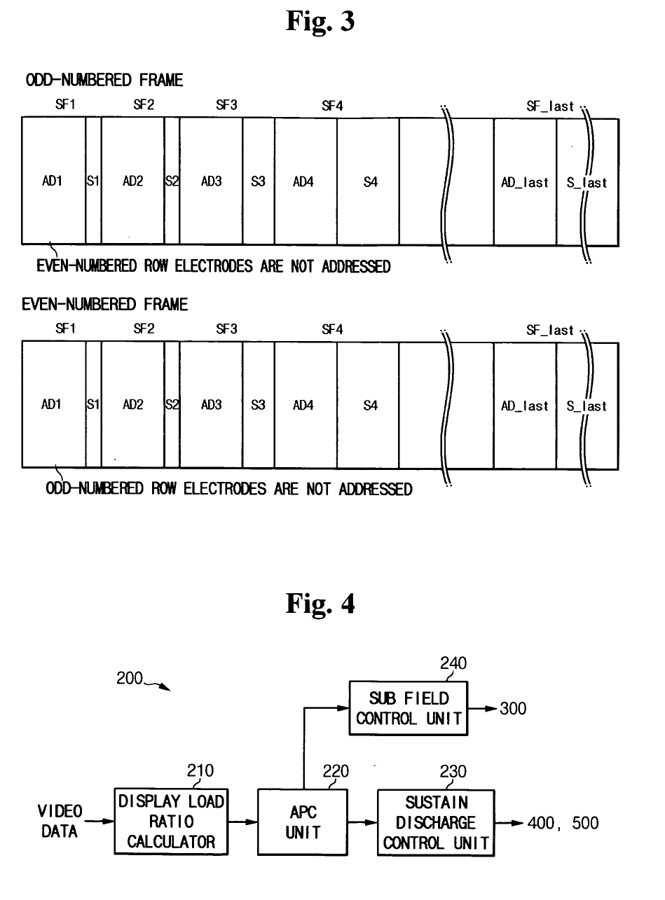

Moreover, while the scan pulse is applied to some of the Y electrodes to address some of the row electrodes in the first embodiment of the present invention, the scan pulse can be applied to every Y electrode as shown in FIG. 3 which illustrates frames divided into a plurality of sub-fields according to a second embodiment of the present invention.

Referring to FIG. 3, in the address period AD1 of the sub-field SF1 of an odd-numbered frame, the Y electrode driver 500 selectively applies the scan pulse to the Y electrodes Y₁ to Yₙ while the A electrode driver 300 applies the non-address voltage to the A electrodes A₁ to Aₘ when the scan pulse is supplied to even-numbered Y electrodes and applies the address pulse to A electrodes of lit cells when the scan pulse is supplied to odd-numbered Y electrodes. Similarly, in the address period AD1 of the sub-field SF1 of an even-numbered frame, the Y electrode driver 500 applies the non-address voltage to the A electrodes A₁ to Aₘ when the scan pulse is applied to the odd-numbered Y electrodes. Then, address discharge and sustain discharge occur only in the odd-numbered row electrodes in the odd-numbered frame, whereas address discharge and sustain discharge occur only in the even-numbered row electrodes in the even-numbered frame. Accordingly, the scan pulse is selectively applied to the Y electrodes Y₁ to Yₙ and thus the conventional driver for applying the scan pulse can be applied to the second embodiment of the present invention.

A high display load ratio of the plasma display panel increases power consumption. Thus, an automatic power control (APC) method is generally used in order to restrict the power consumption within a specific range. The APC method reduces the power consumption by reducing the number of sustain discharge pulses in response to the display load ratio. When the plasma display panel has a low display load ratio and thus the number of sustain discharge pulses is large, the number of sustain discharge pulses allocated to each sub-field is also large. In this case, there is no need to reduce the luminance of the sub-field having the minimum weight in order to improve representation of lower gray scale. On the other hand, when the plasma display panel has a high display load ratio and thus the number of sustain discharge pulses is small, the number of sustain discharge pulses allocated to each sub-field is also small so that the luminance of the sub-field with the minimum weight may be relatively high. Accordingly, the driving methods according to the first and second embodiment of the present invention can be applied only when the plasma display panel has a high display load ratio.

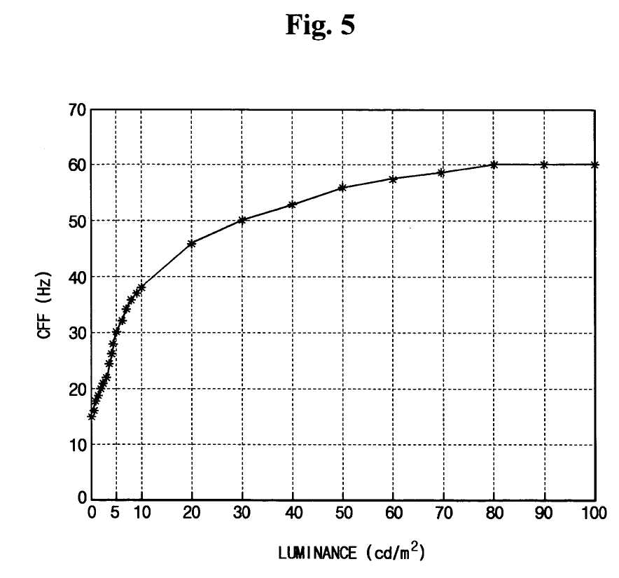

According to the first and second embodiments of the present invention, the sub-field SF1 with the minimum weight is substantially driven at 30 Hz so that flicker may be generated. However, if the luminance of the sub-field SF1 is lower even when the sub-field SF1 is driven at 30 Hz, flicker may not be recognized. Thus, the first and second embodiments of the present invention can be applied only when the luminance of the sub-field SF1 is lower than a critical value. This will now be explained with reference to FIGS. 4 and 5.

FIG. 4 is a block diagram of the controller 200 of the plasma display device according to a third embodiment of the present invention, and FIG. 5 is a graph showing the relationship between a critical flicker frequency and luminance.

Referring to FIG. 4, the controller 200 includes a display load ratio calculator 210, an APC unit 220, a sustain discharge control unit 230, and a sub-field control unit 240. The controller 200 can further include an analog/digital converter for converting an input analog video signal into digital video data, and an inverse gamma corrector for inverse-gamma-correcting gamma-corrected video data. Furthermore, the controller 200 may carry out error diffusion for diffusing an error of video data to adjacent cells in order to improve representation of gray scales of the video data.

The display load ratio calculator 210 calculates a display load ratio from gray scales of video data corresponding to one frame. As represented by Equation 1 below, the display load ratio calculator 210 calculates an average signal level ASL of the video data corresponding to one frame, determines a high display load ratio when the average signal level is high, and determines a low display load ratio when the average signal level is low. That is, when the average signal level is high, there is a large number of lit cells and thus the display load ratio becomes high. On the contrary, when the average signal level is low, there is a small number of lit cells and thus the display load ratio becomes low.

$$ASL = ( {\sum }_{V}^{} {R}_{n} + {\sum }_{V}^{} {G}_{n} + {\sum }_{V}^{} {B}_{n} ) / 3 N \qquad [ Equation 1 ]$$

Here, Rₙ, Gₙ, and Bₙ, are signal levels of R, G, and B video data items, respectively, V denotes one frame, and 3N represents the number of R, G, B video data input for one frame.

The APC unit 220 determines the total number of sustain discharge pulses allocated to one frame based on the display load ratio calculated by the display load ratio calculator 210. When the display load ratio is high and thus a large number of lit cells increases power consumption, the APC unit 220 reduces the total number of sustain discharge pulses. When the display load ratio is low and thus a small number of lit cells decreases power consumption, the APC unit 220 increases the total number of sustain discharge pulses. The relationship between the total number of sustain discharge pulses and the display load ratio can be stored in the form of a lookup table in a memory or calculated through a logical operation.

The sustain discharge control unit 230 determines the number of sustain discharge pulses allocated to each sub-field based on the total number of sustain discharge pulses determined by the APC unit 220 and controls the sustain electrode driver 400 and the scan electrode driver 500 such that the drivers 400 and 500 supply corresponding sustain discharge pulses in each sub-field.

The sub-field control unit 240 maps video data to a plurality of sub-fields SF1 to SF8 to generate sub-field data and transmits the sub-field data to the address electrode driver 300. Then, the address electrode driver 300 controls the address pulse applied to the address electrodes in the sub-fields SF1 to SF8 in response to the sub-field data. The sub-field data represents whether a corresponding cell is lit or not in each sub-field.

The total number of sustain discharge pulses, which is determined by the APC unit 220 in response to the display load ratio, determines the number of sustain discharge pulses allocated to the sub-field SF1 with the minimum weight and the luminance of the sub-field SF1. Referring to FIG. 5, it can be seen that a critical flicker frequency (CFF) is varied with luminance. This obeys Ferry-Porter's law that light flickering at more than a specific cycle is recognized as continuous light. In FIG. 5, the luminance corresponding to the critical flicker frequency of 30 Hz is approximately 5 cd/m². Thus, flicker may not be recognized when the luminance of the sub-field SF1 with the minimum weight, in which only some of the row electrodes are addressed as shown in FIGS. 2 and 3, is less than 5 cd/m². That is, only some of the row electrodes can be addressed, as shown in FIGS. 2 and 3, in a sub-field whose luminance is less than 10 cd/m² when the row electrodes are addressed.

Accordingly, the APC controller 200 addresses only some of the row electrodes in the sub-field SF1 with the minimum weight when the total number of sustain discharge pulses sets the luminance of the sub-field SF1 with the minimum weight SF1 to less than 10 cd/m² in response to the calculated display load ratio. The APC controller 200 transmits control information for addressing only some of the row electrodes to the A electrode driver 300 and the Y electrode driver 500.

While the display load ratio calculator 210 calculates the display load ratio using the average signal level of video data in the third embodiment of the present invention, the display load ratio can be calculated using sub-field data. That is, the display load ratio calculator 210 can convert the video data into the sub-field data and calculate the number of lit cells through the sub-field data to calculate the display load ratio.

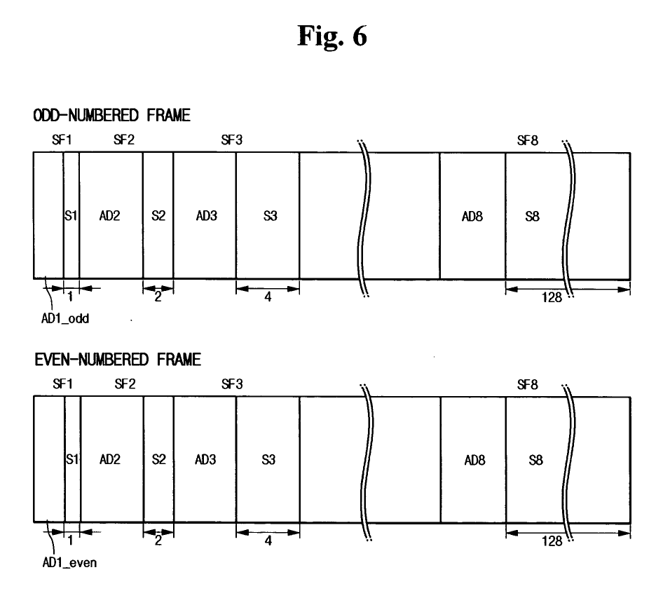

While the first, second and third embodiments of the present invention add a sub-field with a low luminance to a frame to improve representation of lower gray scale, the methods according to the first, second, and third embodiments of the present invention can be applied to conventional sub-fields, which will be explained with reference to FIG. 6.

FIG. 6 illustrates frames divided into a plurality of sub-fields according to a fourth embodiment of the present invention. In FIG. 6, one frame is divided into eight sub-fields SF1 to SF8 respectively having weights 1, 2, 4, 8, 16, 32, 64, and 128.

When the total number of sustain discharge pulses determined by the APC unit 220 of FIG. 5 is 1020, for example, the numbers of sustain discharge pulses allocated to the sub-fields SF1 to SF8 corresponds to 4, 8, 16, 32, 64, 128, 256, and 512 according to their weights, respectively. When the total number of sustain discharge pulses is 128, the number of sustain discharge pulses allocated to the sub-field SF1 having the minimum weight should be 0.5. However, the number of sustain discharge pulses must be an integer.

Accordingly, the APC unit 220 allocates a single sustain discharge pulse to the sub-field SF with the minimum weight and transmits control information to the sustain discharge control unit 230 and the sub-field control unit 240 such that only odd-numbered row electrodes or even-numbered row electrodes are addressed. Then, the odd-numbered row electrodes and even-numbered row electrodes are alternately addressed for each frame, as shown in FIG. 6.

While a 1/2 sustain discharge pulse is applied to the sub-field SF1 with the minimum weight in the fourth embodiment of the present invention, the APC unit 220 can use the driving method according to the fourth embodiment of the present invention when the display load ratio is higher than a critical value. The critical value can correspond to a display load ratio when there exists a sub-field requiring a luminance lower than the luminance when a single sustain discharge pulse is applied. Furthermore, while the plurality of row electrodes are divided into the odd-numbered row electrodes and even-numbered row electrodes in accordance with the fourth embodiment of the present invention, it is possible to divide the plurality of row electrodes into a plurality of groups and set cells of the row electrodes corresponding to some of the plurality of groups as lit cells.

Moreover, when the sub-field SF1 requires a 1/4 sustain discharge pulse and the sub-field SF2 requires a 1/2 sustain discharge pulse, 1/4 of the row electrodes can be addressed in the sub-field SF1 and 1/2 of the row electrodes can be addressed in the sub-field SF2.

According to the present invention, only some row electrodes are addressed in a sub-field with a lower weight, which requires lower luminance, to reduce the luminance of the sub-field with lower weight. Consequently, representation of lower gray scale can be improved.

While this invention has been described in connection with what is presently considered to be practical and exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
a display panel having a plurality of row electrodes, a plurality of column electrodes intersecting the row electrodes, and a plurality of cells respectively defined by the row electrodes and column electrodes;
a controller adapted to divide one field into a plurality of sub-fields having respective weights, to generate control signals for controlling driving of the row electrodes and column electrodes from video data, to calculate a display load ratio from the video data, and to determine the number of sustain discharge pulses allocated to each of the sub-fields in response to the display load ratio; and
a driver adapted to select cells to be lit from the plurality of cells in an address period of each sub-field, and to apply sustain discharge pulses of as many as the weight of each sub-field to the row electrodes in a sustain period of each sub-field such that the selected cells are lit for a period of time corresponding to the number of the sustain discharge pulses,
wherein the controller sets the cells corresponding to some of the plurality of row electrodes to non-lit cells all the time in at least one sub-field.

2. The plasma display device of claim 1, wherein the controller determines the row electrodes corresponding to the cells set to be non-lit cells frame by frame.

3. The plasma display device of claim 2, wherein at least one sub-field includes a first sub-field having the smallest weight, and the controller sets cells corresponding to odd-numbered row electrodes to the non-lit cells in one frame and sets cells corresponding to even-numbered row electrodes to the non-lit cells in the next frame.

4. The plasma display device of claim 2, wherein the sub-field in which the cells corresponding to some of the row electrodes are set to be non-lit cells includes the first sub-field having the smallest weight and a sub-field having the second smallest weight, and the number of row electrodes having cells set to be non-lit cells in the first sub-field is larger than the number of row electrodes having cells set to be non-lit cells in the second sub-field.

5. The plasma display device of claim 1, wherein the sub-field in which the cells corresponding to some of the row electrodes are set to be non-lit cells has a luminance lower than 10 cd/m² when the row electrodes are addressed.

6. The plasma display device of claim 1, wherein the controller sets the cells corresponding to some of the row electrodes to the non-lit cells when the display load ratio is higher than a critical value.

7. The plasma display device of claim 1, wherein the number of sustain discharge pulses allocated to the sub-field in which the cells corresponding to some of the row electrodes to the non-lit cells is identical to the number of sustain discharge pulses allocated to a sub-field having a weight that is larger than and next to the weight of the sub-field.

8. The plasma display device of claim 1, wherein the driver selectively applies a scan pulse to row electrodes other than some of the row electrodes having the cells set to be non-lit cells in the address period of the sub-field in which the cells corresponding to some of the row electrodes are set to be non-lit cells.

9. The plasma display device of claim 1, wherein the driver selectively applies a scan pulse to the plurality of row electrodes in the address period of the sub-field in which the cells corresponding to some of the row electrodes are set to be non-lit cells, and applies a pulse for setting non-lit cells to the column electrodes when the scan pulse is applied to some of the row electrodes.

10. A method for driving a plasma display device having a plurality of row electrodes, a plurality of column electrodes intersecting the row electrodes, and a plurality of cells respectively defined by the row electrodes and column electrodes, one field being divided into a plurality of sub-fields having respective weights, comprising:
selecting cells to be lit from cells corresponding to row electrodes of a first group among the plurality of row electrodes in at least one first sub-field of a first frame, and lighting the selected cells for a period corresponding to the weight of the first sub-field;
selecting cells to be lit from the cells corresponding to the plurality of row electrodes in at least one second sub-field of the first frame, and lighting the selected cells for a period corresponding to the weight of the second sub-field;
selecting cells to be lit from cells corresponding to row electrodes of a second group among the plurality of row electrodes in the first sub-field of a second frame, and lighting the selected cells for a period corresponding to the weight of the first sub-field; and
selecting cells to be lit from the cells corresponding to the plurality of row electrodes in at least one second sub-field of the second frame, and lighting the selected cells for a period corresponding to the weight of the second sub-field.

11. The method of claim 10, wherein the row electrodes of the first group are different from the row electrodes of the second group.

12. The method of claim 11, wherein the row electrodes of the first group are odd-numbered row electrodes, and the row electrodes of the second group are even-numbered row electrodes.

13. The method of claim 10, wherein the first sub-field has the smallest weight.

14. The method of claim 10, wherein the first sub-field has a luminance less than 10 cd/m² when the row electrodes are addressed.

15. A plasma display device comprising:
a display panel having a plurality of row electrodes, a plurality of column electrodes intersecting the row electrodes, and a plurality of cells respectively defined by the row electrodes and column electrodes;
a controller adapted to divide one frame into a plurality of sub-fields having respective weights, to generate control signals for controlling driving of the row electrodes and column electrodes from video data, to calculate a display load ratio from the video data, and to determine the number of sustain discharge pulses allocated to each of the sub-fields in response to the display load ratio; and
a driver adapted to selectively apply a scan pulse to the plurality of row electrodes in each sub-field, and to apply an address pulse to column electrodes corresponding to cells to be lit among cells corresponding to the row electrodes to which the scan pulse is applied, to address the lit cells,
wherein the controller controls the number of row electrodes addressed at a first display load ratio to be smaller than the number of row electrodes addressed at a second display load ratio smaller than the first display load ratio in at least one first sub-field.

16. The plasma display device of claim 15, wherein the controller controls the number of the row electrodes to which the scan pulse is applied at the first display load ratio to be smaller than the number of the row electrodes to which the scan pulse is applied at the second display load ratio.

17. The plasma display device of claim 15, wherein the first sub-field has the smallest weight.

18. The plasma display device of claim 17, wherein the first display load ratio corresponds to a display load ratio when the number of sustain discharge pulses allocated to the first sub-field is calculated to be smaller than 1 by a ratio of the weight of a second sub-field to the weight of the first sub-field based on the number of sustain discharge pulses allocated to the second sub-field.

19. The plasma display device of claim 17, wherein the row electrodes addressed in the first sub-field of a first frame are different from the row electrodes addressed in the first sub-field of a second frame at the first display load ratio.

20. The plasma display device of claim 19, wherein odd-numbered row electrodes are addressed in the first sub-field of the first frame and even-numbered row electrodes are addressed in the sub-field of the second frame at the first display load ratio, and the row electrodes are addressed in the first sub-field at the second display load ratio.
